(19) United States
(12) Patent Application Publication
(10) Pub. No.: US 2004/0247250 A1
(43) Pub. Date: Dec. 9, 2004

(54) Integrated sleeve pluggable package

(75) Inventor: James C. Lee, Plymouth, MN (US)

Correspondence Address: WORKMAN NYDEGGER (F/K/A WORKMAN NYDEGGER & SEELEY), 60 EAST SOUTH TEMPLE, 1000 EAGLE GATE TOWER, SALT LAKE CITY, UT, 84111, US

(73) Assignee: Honeywell International Inc.

(21) Appl. No.: 10/453,307

(22) Filed: Jun. 3, 2003

(51) Int. Cl. G02B 6/38

(52) U.S. Cl. 385/55; 385/62

(57) ABSTRACT

A pluggable connectorized package having an optical medium component and an optoelectronic element component in a sleeve. Alignment between these components may be maintained by the sleeve. The sleeve may have a slit, be slightly undersized relative to the components, and hold the components with a form of a grip. Or the sleeve may not have a slit and be machined along with the components to fit in the sleeve with close tolerances. The optical medium such as an optical fiber may be in a ferrule to be placed in the sleeve. The optoelectronic element may be in a ferrule-like device that may be referred to as a thimble. The thimble forms an environmentally protective housing for the original equipment chip with design options for full hermeticity as well as providing means of electrical interface. Additionally, this element may be configured to accommodate auxiliary chip-to-fiber coupling optics as required.

The invention pertains to couplers and connectors and particularly to connectors of optical fibers and optoelectronic elements. More particularly, it pertains to a containing aspect of these connectors.

Several patent documents may be related to optical connections between optoelectronic elements and optical media. They include U.S. Pat. No. 6,086,263 by Selli et al., issued Jul. 11, 2000, entitled “Active Device Receptacle” and owned by the assignee of the present application; U.S. Pat. No. 6,302,596 B1 by Cohen et al., issued Oct. 16, 2001, and entitled “Small Form Factor Optoelectronic Receivers”; U.S. Pat. No. 5,692,083 by Bennet, issued Nov. 25, 1997, and entitled “In-Line Unitary Optical Device Mount and Package therefore”; and U.S. Pat. No. 6,536,959 B2, by Kuhn et al., issued Mar. 25, 2003, and entitled “Coupling Configuration for Connecting an Optical Fiber to an Optoelectronic Component”; which are herein incorporated by reference.

In the context of the invention, the optoelectronic element may be understood as being a transmitter or a receiver. When electrically driven, the optoelectronic element in the form of a transmitter converts the electrical signals into optical signals that are transmitted in the form of light signals. On receiving optical signals, the optoelectronic element in the form of a receiver converts these signals into corresponding electrical signals that can be tapped off at the output. In addition, an optical fiber is understood to be any apparatus for forwarding an optical signal with spatial limitation, in particular preformed optical fibers and so-called waveguides.

Couplers and/or connectors for optical elements and fiber may be cumbersome and expensive because of the alignment and fabrication issues.

### SUMMARY

The invention is a connector incorporating a low-cost package design for connecting an optoelectronic element to an optical medium using standard kinds of parts. The optoelectronic element may a device such as a photo detector or light source. The optical medium and element may be connected with a split sleeve. Parts used for the present invention may be readily available and reasonable in terms of cost.

An illustrative example of the invention optical connection system may include a support structure, a holding structure attached to said support structure and an optical medium holder held by the holding structure. The holding structure may have a sheet or layer of material semi-enclosing the optical medium holder. This sheet or layer may form the split sleeve which may apply a pressure of contact at least partially around on the optical medium holder and an optoelectronic element holder. The sleeve may maintain the alignment of the optical medium holder with the optoelectronic element holder with virtually no wiggle. The optical medium holder and the optoelectronic holder may have an outside diameter slightly larger than an inside diameter of the sleeve with the optical medium holder not in the sleeve. The inside diameter of the sleeve may be expanded against a spring-like tension to a size of the outside diameters of the optical medium holder and the optoelectronic element holder when the holders are in the sleeve. The optical medium holder may hold an optical fiber and the optoelectronic element holder may hold a light source. The light source may be a laser, and more specifically may be a vertical cavity surface emitting laser. The optical fiber may be a single mode fiber. The sleeve structure may maintain a certain alignment between an end of the single mode fiber and the vertical cavity surface emitting laser. The ends of both holders with the light source and the fiber may be brought up against each other. Instead of a light source, the optoelectronic element holder may hold a detector.

An instance of the present system may involve a split sleeve available from certain vendors. Such may be inexpensive (less than one U.S. dollar in year 2003). Sleeve may be inserted in a portion of a barrel of a connector housing. The securing of sleeve to the portion of the barrel is not needed. Split sleeve 13 may be free to mechanically float. However, for mechanical attachment purposes, not alignment reasons, the sleeve may be fixed to an inside surface of a portion of a metal barrel housing with a weld or some other securing mechanism such as a mechanical fastener, an adhesive or other material. In the split sleeve approach, a strip of metallization may be applied to the outside surface along a length of a zirconia split sleeve opposite of the slit. The metallization may be fired on the sleeve using one of several available metallization techniques. The sleeve can be secured at the area of metallization in position relative to a receptacle housing or connector barrel with solder, brazing, or an adhesive. Other techniques and materials may be used for assuring secure attachment of the sleeve to the housing or barrel. The metallization defines the surface area of the sleeve to be bonded so that only the desired area is attached. A downside with using an adhesive is that some adhesives might migrate resulting in a shift or loss of bonding between the sleeve relative to the housing or the barrel. The split sleeve may need to flex in order to hold a fiber optic ferrule and the laser holder firmly in their appropriate positions. With this approach, precise alignment of the ferrule and the laser may be achieved and maintained by the zirconia split sleeve.

### BRIEF DESCRIPTION OF THE DRAWING

FIG. 1 shows the relative positions in a sleeve of a ferrule having a fiber and a thimble holding an optoelectronic element;

FIG. 1a may be similar to FIG. 1 except that the ferrule and thimble ends are nearly as close as possible to each other;

FIG. 1b shows the relative positions in a sleeve of a thimble holding an optoelectronic element and another thimble holding an optoelectronic element;

FIG. 1c may be similar to FIG. 1 except that the thimble ends are nearly as close as possible to each other;

FIG. 1d shows the relative positions in a sleeve of a ferrule having a fiber and another ferrule having a fiber;

FIG. 1e may be similar to FIG. 1 except that the ferrule ends are nearly as close as possible to each other;

FIG. 2 reveals a split sleeve which may hold the ferrule and the thimble;

FIG. 3 shows the split sleeve with a patch of metallization formed it;

FIG. 4 is an exploded view of the present connector having a housing;

FIG. 5 is a group of aligned views of the sleeve; and

FIG. 6 is a cross sectional view of the optical connector in FIG. 4 at about the end of the ferrule.

### DESCRIPTION

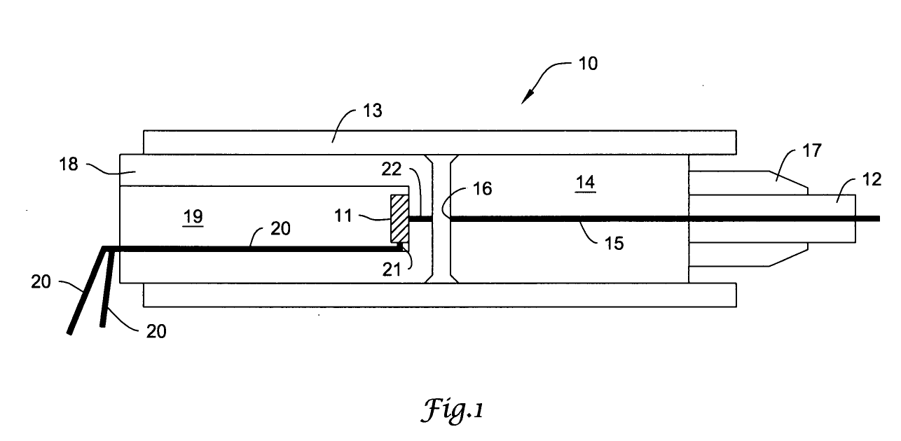

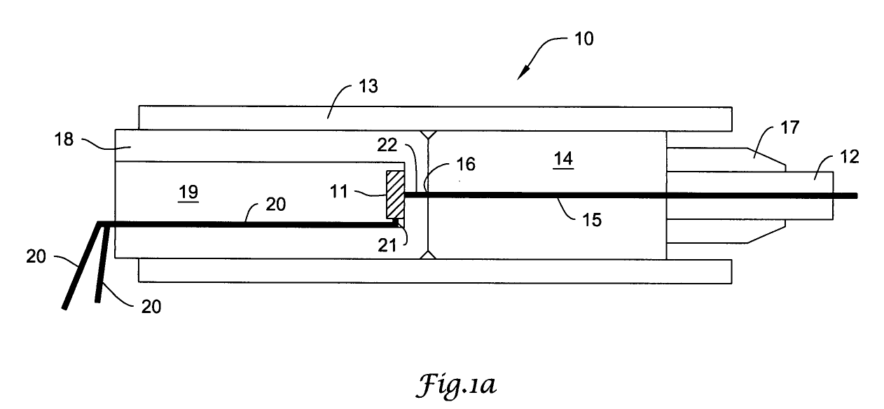

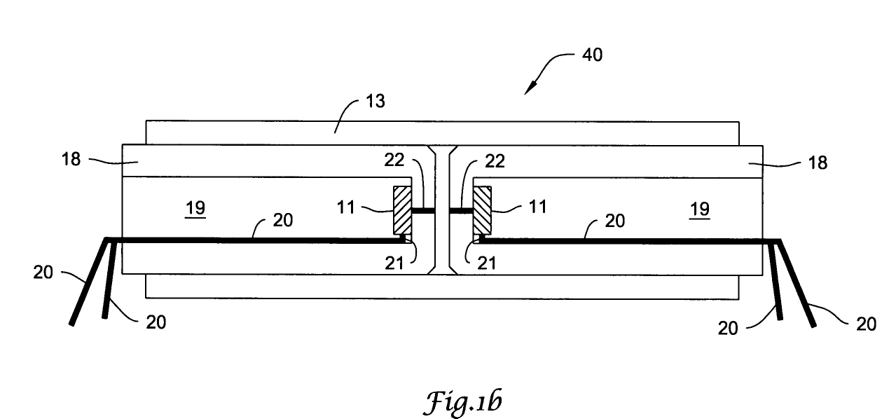

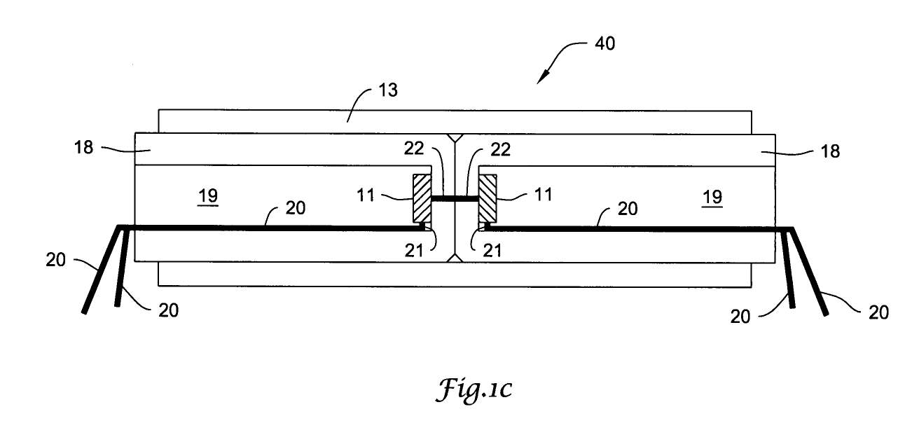

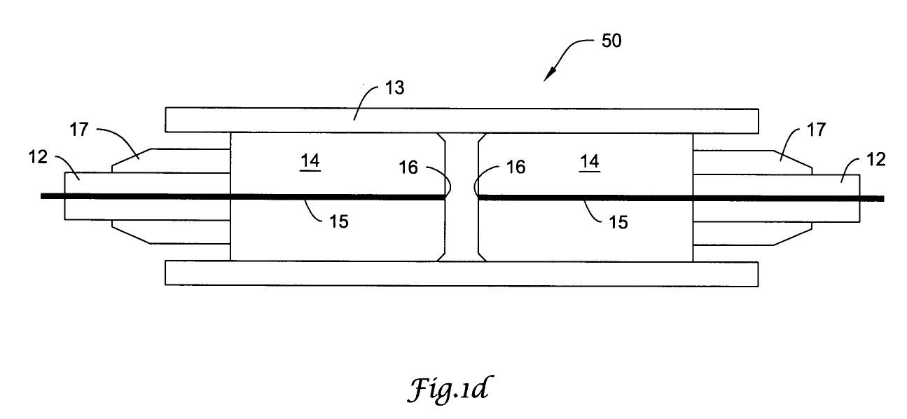

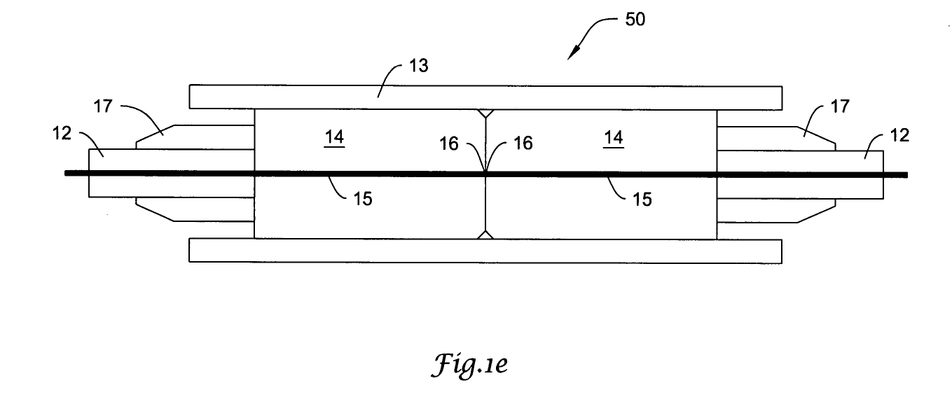

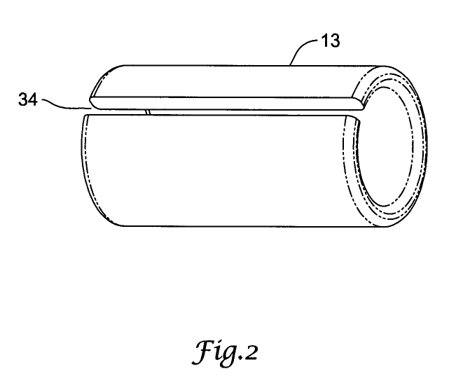

In FIG. 1 shows a sectional view of an optical connector 10 that may connect an optoelectronic element 11 and an optical fiber 12 with each other. Structure 13 may be a split sleeve. A split 34 may be longitudinal along the length of sleeve 13 as shown in FIG. 2. Sleeve 13 may be flexible in that if an object were plugged into the sleeve, sleeve 13 may expand to accept the object that has an outside diameter a little larger than the inside diameter of the sleeve. Such an object may be a ferrule 14 of fiber 12. Ferrule 14 slightly expands sleeve 13 so that ferrule may be inserted. Sleeve 13 may provide a spring-like tension around ferrule 14 thereby holding snug in the sleeve 13. A glass core 15 of fiber 12 fits into a hole of ferrule 14 and extents and is exposed at end 16 of ferrule 14. Ferrule may also have a flange 17 which may provide strain relief protection for fiber 12 and a handle or grip for inserting and removing ferrule 14 from sleeve 13.

At the other end of sleeve 13 may be inserted a thimble-like structure or thimble 18. The thimble forms an environmentally protective housing for the original equipment chip with design options for full hermeticity as well as providing means of electrical interface. Additionally, this element may be configured to accommodate auxiliary chip-to-fiber connecting optics as required. Thimble 18 with a cavity or an opening, cavity or hole 19 may be formed from an ordinary optical fiber ferrule by drilling or hollowing out the ferrule. Or thimble 18 may be fabricated or machined from of raw material. At the end of opening or hollow cavity 19 may be placed optoelectronic element 11. Element 11 may be electrically connected externally from thimble 18 with conductors 20. Conductors 20 may be metal strips formed on the inside wall of cavity 19. Conductors 20 may be connected to element 11 with a metal strips or bond wires 21. At the bottom or end of cavity 19 in thimble 18 may be a hole or aperture 22. It may be the original hole of the fiber ferrule that was use to make thimble 18. Aperture 22 is where radiation or light may enter or exit element 11.

FIG. 1 shows a small space between the end of thimble 18 and the end of ferrule 14. FIG. 1a shows the ends of ferrule 14 and thimble 18 in contact with each other.

FIG. 1b shows an optical connector 40 having two thimbles 18 in sleeve 13. Thimbles 18 are a short distant from each other. FIG. 1c shows thimbles 18 of connector 40 virtually in contact with each other. Optical communication may occur between optoelectronic elements 11 via passages 22 of thimbles 18. In connector 40, one element 11 may be a light source such as a VCSEL and the other element 11 may be a detector. This combination may be useful for manually reconfigurable patch cord/switchboard scenarios.

FIG. 1d shows an optical connector 50 having two ferrules 14 in sleeve 13. Ferrules 14 have fiber core ends 16 at a short distant from each other. FIG. 1e shows ferrules 14 of connector 50 virtually in contact with each other. Optical communication may occur between optical fibers 12 via cores 15 and ends 16, respectively.

Split sleeve 13 may be made from a zirconia ceramic material. This material may be exceptionally hard. It may be machined or molded or extruded with exceptional precision. It also may be dimensionally stable over temperature changes. The zirconia ceramic may flex and be springy. Ferrule 14 and thimble 18 may be made of the same material as that of sleeve 13. Thus, the coefficients of thermal expansion of sleeve 13, ferrule 14 and thimble may be about the same.

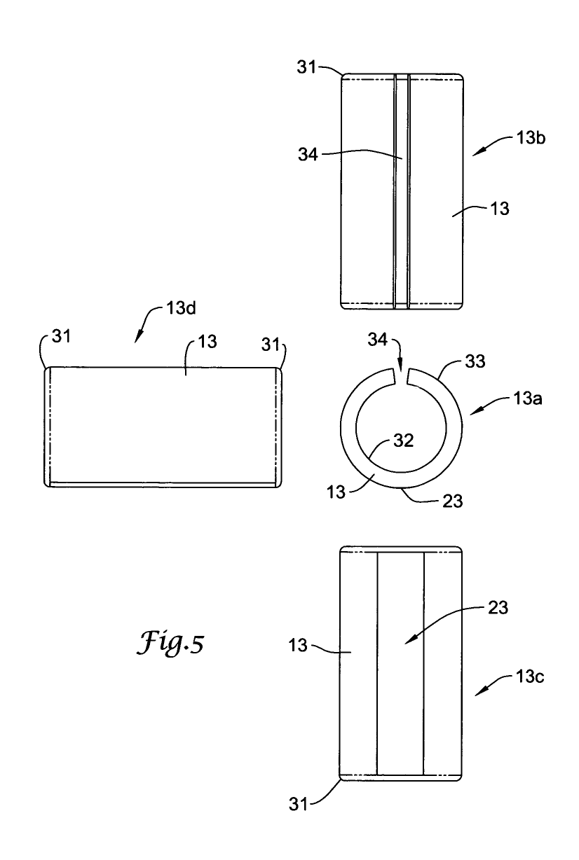

Sleeve 13 may be machined with or without slit 34. It may be machine so that ferrule 14 and thimble 18 fit in sleeve with very small or tight tolerances between the inside surface (surface 32 in FIG. 5) of sleeve 13 and the outside surfaces of ferrule 14 and thimble 18. This fit of ferrule 14 and thimble 18 inside sleeve 13 would virtually not expand sleeve 13 but yet result in almost no clearance between the inside surface of sleeve 13 and the external surfaces of ferrule 14 and thimble 18. The use of the same material in the composition of sleeve 13, ferrule 14 and thimble 18 may result in maintaining the very close clearances among these parts, even over temperature changes.

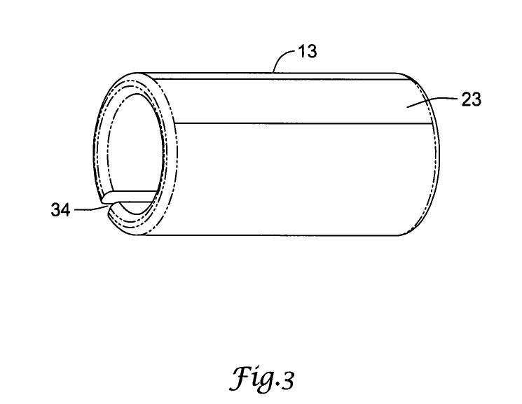

Sleeve 13 may be inserted and attached to a connector housing. If the housing is metal, a metal-to metal bonding may be attained. To make that kind of attachment feasible, a metallization strip 23 may be formed an on external surface of sleeve 13 along its length as shown in FIG. 3. Strip 23 is directly opposite from slit 34.

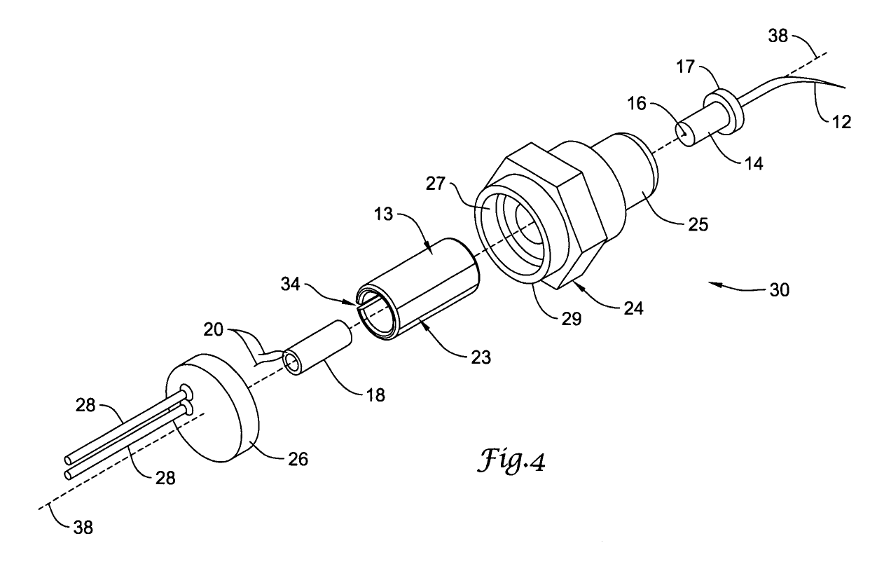

FIG. 4 shows an exploded view of an assembly 30 including optical connector 10 along a longitudinal axis 38. This Figure shows how the parts of connector 10 fit within a protective housing or barrel 24 in assembly 30. Sleeve 13 may be inserted in portion 25 of barrel 24. The securing of sleeve 13 to portion 25 or barrel 24 is not needed. Split sleeve 13 may be free to mechanically float. However, for mechanical attachment purposes, not alignment reasons, sleeve 13 may be fixed to an inside surface of portion 25 or a main portion of metal barrel 24 with a weld or some other securing mechanism such as a mechanical fastener, an adhesive or other material. Upon the attaching sleeve to a portion of barrel 24, ferrule 14 and thimble 18 may be inserted in sleeve 13. An end cap or plate 26 may be placed on an open end 27 of barrel 24. However, before end cap 26 is completely installed on end 27, conductors 20 may be connected to leads 28. Cap or plate 26 may be situated within end 27 with the outside perimeter of plate 26 fitting inside or on edge 29. Plate or cap may be bonded, glued or welded, among other things, to end 27 and edge or rim 29. Instead, plate 26 and edge 29 may have matching threads and plate or cap 26 may be screwed on the end of barrel 24. Or cap or plate 26 may be press fitted onto the end of barrel 24.

FIG. 5 shows several views 13a, 13b, 13c and 13d, of sleeve 13. View 13a is an end view of sleeve 13 that reveals the radii of an inside surface 32 and outside surface 33. The radius of inside surface 32 may be 1.250+0.002/−0.000 mm (0.04921200+0.00007900/−0.00000000 in.). The radius of outside surface 33 may be 1.689±0.002 mm (0.0665±0.0001 in.). There may be a slit or space 34 in sleeve 13 which amounts to about 15 degrees of the circumference of sleeve 13 and extends about the length of sleeve 13 as shown in view 13b. On the surface of sleeve 13 directly opposite from slit 34 may be a metallization layer 23 on outer surface 33. Layer 23 may cover about 45 degrees of the circumference of surface 33 and be about the length of sleeve 13 as shown in view 13c. The thickness of metallization layer may be about 0.005 mm (0.0002 in.). View 13d shows sleeve 13 from the side with the metallization surface facing downward. The length of sleeve 13 may be about 3.302+0.012/−0.025 mm (0.1300+0.0005/−0.0010 in.). The edges 31 of sleeve 13 may have a radius of about 0.08 mm (0.003 in.) as illustrated in view 13d.

Some of the dimensions and tolerances may differ for industry standard assembly LC, SC and MU types of fiber optic connectors. The outside diameter of ferrule 14 may be about 2499+/−0.5 for the SC, or 1249+/−0.5 for the LC or MU connector types. Its length may be about 10 to 13 mm to accommodate various strain relief fiber housing external plug mechanical design variations. The diameter of the hole for fiber 15 may be about 125 to 126+1.0/−0.0 microns to accommodate variously specified standard multimode (MM) and single mode (SM) cable jacketed outside diameters. The outside diameter of thimble 18 may be about 2499+0.0/−0.5 microns for the SC, or 1249+0.0/−0.5 for the LC or MU types. Its length may be about 6 to 13 mm and is not critical and so may be adjusted to minimize overall package depth as required. The only constraint is that thimble 18 be at least three times its diameter (7.5 mm for the SC and 3.75 mm for LC/MU types) so as to be well aligned with the sleeve upon insertion. The diameter of the opening, cavity or hole 19 for optoelectronic element 11 may be about 2100 microns for the SC and 850 microns for LC/MU types, and this dimension is not critical. It is designed to be as large as possible to most easily accommodate the inserted OE chip, consistent with thimble sidewall strength and ease of manufacture.

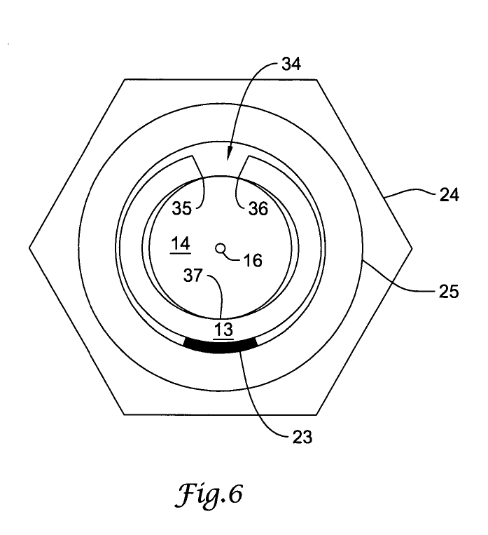

FIG. 6 is a cross-section view at about the fiber core end 16 and looking at the end surface of ferrule 14. Ferrule 14 may be substituted with thimble 18 in FIG. 6 and the following description. The same explanation may apply relative to the holding of thimble 18 in place by sleeve 13. This Figure is not drawn to scale. Sleeve 13 may be secured and brazed to barrel 24 in portion 25 at metallization 23 area. As ferrule 20 or thimble 18 is inserted into sleeve 13, it may flex, spring or stretch out sleeve 13 and slightly widen slit 34. Since sleeve 13 may tend to return to its original shape, tension may be maintained on ferrule 14 and thimble 18 by sleeve 13 at points or surfaces 35 and 36 at about the inner edges of slit 34, and at point or surface 37 opposite of slit 34. The three places 35, 36 and 37 of contacts under pressure between sleeve 13 and ferrule 14 and thimble 18 may firmly hold ferrule 14 and thimble 18 in one position relative to sleeve 13 and to each other. Also, if the ends of ferrule 14 and thimble 18 in sleeve 13 are in contact, there may be more support for ferule 14 and thimble 18 not to move relative to each other. Thus, there would appear to be no wiggle between ferrule 14 and thimble 18. This connecting arrangement also may be done in one and two dimensional arrays.

Although the invention has been described with respect to at least one illustrative embodiment, many variations and modifications will become apparent to those skilled in the art upon reading the present specification. It is therefore the intention that the appended claims be interpreted as broadly as possible in view of the prior art to include all such variations and modifications.

What is claimed is:

1. A connector comprising:
a sleeve;
a ferrule situated in a first end of said sleeve;
a thimble situated in a second end of said sleeve;
an optoelectronic element situated in said thimble; and
an optical medium situated in said ferrule; and
wherein said optoelectronic element is proximate to said optical medium.

2. The connector of claim 1, wherein said sleeve holds said ferrule and thimble in position relative to said sleeve.

3. The connector of claim 2, further comprising:
a passage for light between said optoelectronic element and an end of said thimble; and
a passage for light between said optical medium and an end of said ferrule.

4. The connector of claim 3, wherein:
said sleeve has a slit; and
said sleeve provides a spring-like tension on said ferrule and said thimble to hold said ferrule and thimble in position relative to said sleeve.

5. The connector of claim 4, wherein the end of said thimble and the end of said ferrule are adjacent to each other.

6. The connector of claim 5, wherein:
said optical medium is an optical fiber; and
said optoelectronic element is a vertical cavity surface emitting laser.

7. The connector of claim 6 wherein said optical fiber is single mode fiber.

8. The connector of claim 5, wherein:
said optoelectronic element is a detector; and
said optical medium is an optical fiber.

9. A connector comprising:
a first ferrule having an optical fiber;
a second ferrule having an optoelectronic element; and
a structure; and
wherein said first and second ferrules are situated in said structure.

10. The connector of claim 9, wherein said structure holds said first and second ferrules in place relative to said structure.

11. The connector of claim 10, wherein said first and second ferrules have ends adjacent to each other.

12. The connector of claim 11, wherein:
the end of said first ferrule has a core of the optical fiber exposed; and
the end of said second ferrule has a portion of the optoelectronic element exposed.

13. The connector of claim 12, wherein the core of the optical fiber and the portion of the optoelectronic element are optically connected to each other.

14. The connector of claim 13, wherein said structure is cylindrical and has a slit.

15. The connector of claim 14, wherein said structure hold said first and second ferrules in place with a pressure of tension from said structure against said first and second ferrules.

16. The connector of claim 15, wherein the optical fiber is a single mode fiber.

17. The connector of claim 16, wherein the coefficient of temperature expansion (CTE) is approximately the same as the CTEs of said first and second ferrules.

18. The connector of claim 17, wherein said structure and said first and second ferrules comprise a ceramic having zirconia.

19. The connector of claim 20, wherein said second ferrule is hollowed out for situating the optoelectronic element.

20. The connector of claim 19, wherein the optoelectronic element is aligned with the core at the end of said first ferrule.

21. The connector of claim 20, wherein the optoelectronic device is a surface cavity surface emitting laser (VCSEL).

22. The connector of claim 20, wherein the optoelectronic ferrule is a detector.

23. Means for optical connection comprising:
means for holding an optoelectronic element;
means for holding an optical medium; and
means for holding said means for holding an optoelectronic element and said means for holding an optical medium; and
wherein:
said means for holding an optoelectronic element and said means for holding an optical medium may be placed next to other in an optical alignment in said means for holding said means for holding an optoelectronic element and said means for holding an optical medium; and
the optical alignment enables an optical element and an optical medium to have optical signals propagate between each other.

24. The means of claim 23, wherein an end of said means for holding an optoelectronic element and an end of said means for holding an optical medium may be adjacent to each other.

25. The means of claim 23, wherein said means for holding said means for holding an optoelectronic element and said means for holding an optical medium, holds said means for holding an optical element and said means for holding an optical medium to maintain the optical alignment with a tension.

26. A method for optical connection comprising:
providing a sleeve;
inserting a holder for holding an optoelectronic element into the sleeve; and
inserting a holder for holding an optical medium into the sleeve; and
wherein the sleeve holds the holder for holding an optoelectronic element and the holder for holding an optical medium in a position for an optical alignment.

27. The method of claim 26, wherein the optical alignment permits optical transmission of signals from an optoelectronic element in the holder for holding an optoelectronic element to an optical medium in the holder for holding an optical medium.

28. The method of claim 26, wherein the optical alignment permits optical transmission of signals from an optical medium in the holder for holding an optical medium to an optoelectronic element in the holder for holding an optoelectronic element.

29. A connector comprising:
a sleeve;
a first thimble situated in a first end of said sleeve;
a second thimble situated in a second end of said sleeve;
a first optoelectronic element situated in said first thimble; and
a second optoelectronic element situated in said second thimble; and
wherein said first optoelectronic element is capable of optical communication with said second optoelectronic element.

30. The connector of claim 29, wherein:
said sleeve has a slit; and
said sleeve provides a spring-like tension on said first thimble and said second thimble to hold said first thimble and second thimble in a position relative to said sleeve to maintain an alignment for the optical communication.

31. The connector of claim 29, wherein said first thimble and second thimble fit with close dimensional tolerance in said sleeve to maintain and alignment for the optical communication.

32. A connector comprising:
a sleeve;
a first ferrule situated in a first end of said sleeve;
a second ferrule situated in a second end of said sleeve;
a first optical medium situated in said first ferrule;
and
a second optical medium situated in said second ferrule; and
wherein said first optical medium is capable of optical communication with said second optical medium.

33. The connector of claim 32, wherein:
said sleeve has a slit; and
said sleeve provides a spring-like tension on said first ferrule and said second ferrule to hold said first ferrule and second ferrule in a position relative to said sleeve to maintain an alignment for the optical communication.

34. The connector of claim 32, wherein said first ferrule and second ferrule fit with close dimensional tolerance in said sleeve to maintain and alignment for the optical communication.
